(19) United States
(12) Patent Application Publication
(10) Pub. No.: US 2024/0033988 A1
(43) Pub. Date: Feb. 1, 2024

(54) APPARATUSES, SYSTEMS AND METHODS FOR PRODUCING DENTAL ALIGNERS

(71) Applicant: DIGITAL ORTHODONTIC CARE, Milton (CA)

(72) Inventors: Thomas SEILER, Milton, ON (CA); Jeff SHEPPARD, Milton, ON (CA)

(21) Appl. No.: 18/255,707

(22) PCT Filed: Dec. 3, 2021
(86) PCT No.: PCT/CA2021/051734

§ 371 Date: Jun. 2, 2023

Related U.S. Application Data
(60) Provisional application No. 63/121,173, filed on Dec. 3, 2020.

(51) Int. Cl. B29C 51/10; A61C 7/08; A61C 13/34; B29C 51/46; B33Y 50/00; B33Y 80/00; B29C 51/36; B29C 33/38

(52) U.S. Cl. CPC B29C 51/10; A61C 7/08; A61C 13/34; B29C 51/46; B33Y 50/00; B33Y 80/00; B29C 51/36; B29C 33/3842; A61C 2204/005; B29L 2031/753

(57) ABSTRACT

A method of forming an orthodontic aligner comprises: generating a teeth digital model; generating a digital dental model based thereon; assigning an identifier to the digital model; forming a dental model, marked with the identifier, corresponding to the digital model; coding a RFID chip within a pallet with the identifier; placing the dental model upon the corresponding pallet, based on the identifier, to form a model/pallet pair; placing the model/pallet pair into a model/pallet vessel; placing a biocompatible thermoplastic sheet upon a membrane stretched about a pressurizable chamber; heating the thermoplastic sheet; placing the membrane and the heated sheet adjacent the model/pallet pair; pressurizing the chamber to apply pressure to the membrane to form the sheet onto the model to form a molded aligner sheet; and cooling the molded aligner sheet to form the orthodontic aligner. The membrane creates a physical barrier between the applied pressure and the sheet.

### FIELD OF THE INVENTION

The present invention relates to apparatuses, systems and methods for preparing dental aligners.

### BACKGROUND OF THE INVENTION

Orthodontic aligners are commonly used to align teeth for aesthetic reasons. Each aligner must be customized to a patient individually as no two patients have identical teeth alignment. Clear aligners that appear nearly invisible when used are particularly popular among users who prefer discreet treatment and there is a significant demand for them globally. Clear aligners fit over a patient's teeth to apply forces that move the teeth from an original alignment to a desired alignment. In a treatment plan for an individual patient, depending on the amount of movement required, a number of aligners corresponding to different stages of alignment during the course of treatment may be used to move the teeth gradually from their original positions to the desired positions. This is because each aligner is limited in the amount of displacement that it can effect on the teeth. Generally, each aligner is used for 10 to 14 days to move teeth up to 0.25 mm.

Currently, to form a number of clear aligners for treatment of a single patient, an impression of the patient's teeth is first taken. The dental impression is scanned to obtain a digital model of the original alignment of the teeth. Some practitioners also use intraoral scanners to create a scanned image of the dental arch(es). A treatment plan is then created, comprising a series of teeth digital models of the teeth at different stages of alignment between the original alignment and the desired alignment. A series of dental models are then made, each corresponding to each of the teeth digital models in the treatment plan.

Methods of dental model making are well known, such as the traditional methods of dental model making described in Graber, Orthodontics: Principle and Practice, Second Edition, Saunders, Philadelphia, 1969, pp. 401 415, which involve forming an impression of the patient's dentition using a suitable impression material, as well as improved methods of dental model making including rapid prototyping. Rapid prototyping is a group of techniques involving the use of modern solid modeling CAD packages, combined with laser systems and new materials (e.g., PolyJet™ materials), to generate solid parts directly from a computer model. Construction of the part or assembly is usually done using 3D printing or “additive layer manufacturing” technology. Examples of rapid prototyping technology include, but are not limited to, stereolithography (SLA), laminate object manufacturing (LOM), and fused deposition modeling (FDM), to name a few.

A series of aligners are then made from each of the dental models. The aligners are typically made using thermoforming of a translucent biocompatible thermoplastic sheet onto the dental models (e.g., 3D printed models). Subsequently, the thermoformed thermoplastic sheets are laser-marked and trimmed according to the teeth digital models using CNC machining, and then removed from the dental models. Trimming each aligner results in waste and requires accuracy. In addition, sharp edges that result from the trimming process, which might contact and irritate the gingiva, are smoothed via another post-forming process, such as tumbling and/or polishing/cleaning in order to form the aligners, before packaging, labelling and shipping to the patient.

The cost of the aligners is dictated in part by the cost of the 3D printed model and the amount of precursor thermoplastic material that is used in forming the clear aligner. There are also additional costs due to post-processing and scrap (e.g., if the trimming is in adequate then more time is spent correcting the formed aligner, or the aligner may have to be re-made). It would be desirable to reduce the number of steps required to form each aligner, and/or to reduce the amount of the biocompatible thermoplastic sheet required to produce each aligner, to reduce manufacturing time and/or cost, and potentially reduce the logistical operations required and the waste produced in the fabrication process.

The current state of the art process for producing dental aligners can be summarized as follows:
1. Digitally scan teeth or take dental impressions.
2. Create treatment plan (determine steps required to achieve desired outcome). This is a software- and manpower-intensive process.
3. Print 3D models of treatment stages (approximately 20 individual models per customer). This requires industrial scale 3D printers and expensive material.
4. Clean/degrease models.
5. Fabricate Aligner trays
   a. Uses, for example, polyurethane disk or aligner sheet (6″ diameter and 0.030″ to 0.040″ thick).
   b. Clamp disk around the outer circumference.
   c. Heat disk to 220° C. (approx. 35 sec).
   d. Position disk over 3D model.
   e. Pressurize the upper side of the disk (at 90 to 130 psi) so that it envelopes the 3D form.
   f. Cool the material (approx. 60 sec).
   g. Laser mark company and patient ID.
   h. Trim excess aligner material (typically 80% is waste material).
   i. Remove aligner from arch and discard arch and waste aligner material.
   j. Grind and polish.
   k. Sort and pack.
   l. Ship.

Another drawback in the current state of the art in forming the clear plastic aligner, is that the thermoplastic sheet thins as it is stretched over the model causing it to be less effective and to potentially fail. Due to the need to depress the pre-stretched disk or aligner sheet down until contact is made with the dental model, and then to depress the disk even further to form the disk around the dental model, conventional thermoforming methods produce aligners with variable and unpredictable thicknesses. Excess thinning can cause the aligner to thin and crack which would require that the aligner be re-made by going through the entire process again. Such excess thinning may also result in the aligner cracking on removal from the dental model, or the formed aligner lacking the predicted properties to move the teeth. This would mean that the teeth do not track to the treatment plan, requiring the patient to be rescanned in order to revise the treatment plan and re-form the aligners comprising the treatment plan, a costly process. Furthermore, excess thinning may require the use of thicker precursor thermoplastic material than what would otherwise be required, to compensate for the thinning anticipated during the thermoforming process.

Common materials used for forming dental aligners include ZenduraA™ (a polyurethane), ZenduraFLX™ (a copolyester-polyurethane composite), Atmos™ (a copolyester), Essix™ (a polypropylene/ethylene copolymer), and Erkoflex™ (ethylene vinyl acetate (EVA)).

In known dental aligner thermoforming processes, the plastic precursor sheet is depressed from its clamped/stretched position as much as 2″ into the space above the dental model, which may be an area of about 7″ by ¾″. Since the plastic precursor sheet has a fixed thickness to start, the depressing/stretching of the sheet thins it to as much as 50% of its original thickness. The current process thins the thermoplastic sheet unpredictably. Some have attempted to address this problem by using thicker precursor thermoplastic material, but as noted above, such materials may crack after thermoforming, and further, aligners formed from such thicker plastics can be too strong in certain areas and thus uncomfortable to the patient (e.g., the aligners may be thicker on the occlusal surfaces and therefore cause an uncomfortable bite).

Where current aligner forming processes result in unpredictable thicknesses and/or aligner properties that result in inadequate tooth movement for a particular stage of treatment, the aligner in the next treatment stage will not fit.

Furthermore, in the current the state of the art, a heated disk of material is formed over a model, and then trimmed in a further step to produce the formed aligner, which introduces downstream waste and inefficiencies.

There is a need for improved orthodontic appliances, including improved aligners and the methods for making aligners.

### SUMMARY OF THE INVENTION

In accordance with an aspect of the present invention, there is provided a method of forming an orthodontic aligner, the method comprising:
(a) forming a dental model corresponding to a teeth digital model (e.g., corresponding to mandibular and maxillary arches attained by intraoral scan or a scanned impression);
(b) defining a virtual edge of the aligner corresponding to the teeth digital model wherein the virtual edge and the teeth digital model define a three-dimensional shape of the aligner;
(c) computationally converting the three-dimensional shape into a developed surface having a two-dimensional shape;
(d) cutting the two-dimensional shape from a biocompatible thermoplastic sheet to form a pre-cut aligner sheet; and
(e) thermoforming the pre-cut aligner sheet over the dental model, thereby forming the orthodontic aligner.

In an embodiment, in the step of thermoforming the pre-cut aligner sheet over the dental model, a membrane or bladder is used under the pre-cut aligner sheet. Applicant uses the terms membrane or bladder herein interchangeably.

In an embodiment, the membrane or bladder used under the pre-cut aligner sheet creates a vacuum seal around the dental model during the thermoforming.

In an embodiment, the membrane or bladder is pliable.

In an embodiment, the membrane or bladder comprises a non-stick material.

In an embodiment, the membrane or bladder is reusable over multiple cycles.

In an embodiment, defining the virtual edge comprises defining a line displaced below a gingival line of the teeth digital model around the teeth digital model.

In some aspects there is provided a method of forming an orthodontic aligner. The method may comprise: (a) generating a teeth digital model based on a three dimensional (3D) scan of a patient's teeth; (b) generating a digital dental model based on the teeth digital model; (c) assigning a unique dental aligner identifier to the digital dental model and storing the dental aligner identifier in a database record in a database, the database record containing information pertaining to the patient such that the information comprises the dental aligner identifier; (d) forming a dental model corresponding to the digital dental model, the dental model marked with the aligner identifier corresponding to the digital dental model; (e) coding a radio-frequency identifier (RFID) chip physically associated with a pallet with the aligner identifier; (f) reading the aligner identifier associated with the dental model and the pallet and placing the dental model upon the pallet coded with the corresponding aligner identifier to form a model/pallet pair; (g) placing a biocompatible thermoplastic sheet upon a membrane stretched about a pressurizable chamber; (h) heating the thermoplastic sheet with a heater so as to make the sheet sufficiently pliable to be molded about the dental model; (i) placing the heated sheet and the dental model of the model/pallet pair adjacent one another; (j) pressurizing the chamber to thereby apply pressure to the membrane to form the sheet onto the model to form a molded aligner sheet; and (k) cooling the molded aligner sheet to form the orthodontic aligner. The membrane may create a physical barrier between the applied pressure and the sheet such that the applied pressure forms the membrane onto the model and the pallet and the membrane thereby effects the forming of the sheet onto the model.

In some aspects, the membrane may comprise a non-stick and reusable material.

In some aspects, the method may further comprise: generating a treatment plan comprising a series of digitally simulated digital dental models from a first desired alignment digital dental model to a final desired alignment digital dental model. The method may be carried out for each of the series of digitally simulated digital dental models in the treatment plan, each of the series of digitally simulated digital dental models comprising a respective unique dental aligner identifier.

In some aspects, a material finish of the membrane may affect a surface finish of the formed orthodontic aligner, and stretching the membrane may alter the material finish of the membrane.

In some aspects, the method may further comprise varying a stretch of the membrane to alter the surface finish of the formed orthodontic aligner.

In some aspects, altering the surface finish of the formed orthodontic aligner may comprise altering an opacity of the formed orthodontic aligner.

In some aspects, pressurizing the chamber may comprise applying liquid or air to the membrane under pressure.

In some aspects, the method may further comprise, prior to placing the biocompatible thermoplastic sheet upon the membrane, perforating the sheet.

In some aspects, the method may further comprise marking the formed orthodontic aligner with the information or a portion of the information. The marking may comprise laser marking by a laser marking apparatus that reads the aligner identifier from the RFID chip, queries the database for the information related to the aligner identifier, and laser marks the information or the portion of the information onto the formed orthodontic aligner.

In some aspects, the method may further comprise reading the RFID chip to determine the aligner identifier, querying the database and retrieving the digital dental model corresponding to the aligner identifier, and trimming the formed orthodontic aligner to substantially match the retrieved digital dental model.

In some aspects, the method may further comprise separating the formed orthodontic aligner, the dental model and the pallet, cleaning the pallet for re-use, re-programming the RFID chip with another aligner identifier, and re-using the reprogrammed RFID chip to form a further orthodontic aligner.

In some aspects, the method may further comprise cutting the biocompatible thermoplastic sheet from a precursor thermoplastic sheet. The cutting may comprise using artificial intelligence and/or machine learning to optimize cuts.

In some aspects, the method may further comprise, prior to placing the biocompatible thermoplastic sheet upon the membrane, incorporating additive(s) into the precursor thermoplastic sheet or the cut biocompatible thermoplastic sheet.

In some aspects, the additive(s) may comprise lateral flow assay (LFA) strip(s) or antimicrobial agent(s).

In some aspects, the additive(s) may comprise lateral flow assay (LFA) strip(s).

In some aspects, each of the LFA strip(s) may comprise nanocrystals comprising biomarkers.

In some aspects, the additive(s) may comprise antimicrobial agent(s).

In some aspects, the membrane may be replaceable.

In accordance with further aspects there is provided a method of forming an orthodontic aligner. The method may comprise: (a) forming a dental model corresponding to a teeth digital model; (b) defining a virtual edge of the teeth digital model wherein the teeth digital model with the virtual edge define a three-dimensional shape of the aligner; (c) computationally converting the three-dimensional shape into a developed surface having a two-dimensional shape; (d) cutting the two-dimensional shape from a biocompatible thermoplastic sheet to form a pre-cut aligner sheet; and (e) thermoforming the pre-cut aligner sheet over the dental model, thereby forming the orthodontic aligner.

In some aspects, the method may further comprise, after step (d): (d1) placing the pre-cut aligner sheet onto a membrane housed within a chamber, the membrane forming a physical barrier between the pre-cut aligner sheet and the chamber.

In some aspects, the method may further comprise, after step (d1): (d2) placing the membrane and the pre-cut aligner sheet over the dental model, and pressurizing the chamber to cause the membrane to form the pre-cut aligner sheet over the dental model.

In some aspects, the membrane may be pliable and may comprise a non-stick material reusable over multiple cycles.

In some aspects, defining the virtual edge may comprise defining a line displaced below a gingival line of the teeth digital model around the teeth digital model.

In some aspects, the method may further comprise, before step (a): digitally scanning a patient's teeth to form the teeth digital model, the teeth digital model comprising an original alignment teeth digital model, and generating a treatment plan comprising a series of digitally simulated teeth digital models from the original alignment teeth digital model to a desired alignment teeth digital model.

In some aspects, the method may be carried out for each of the series of digitally simulated teeth digital models in the treatment plan.

In some aspects, a material finish of the membrane may affect a surface finish of the formed orthodontic aligner, and stretching the membrane may alter the material finish of the membrane.

In some aspects, varying a stretch of the membrane may alter the surface finish of the formed orthodontic aligner.

In some aspects, altering the surface finish of the formed orthodontic aligner may comprise altering an opacity of the formed orthodontic aligner.

In some aspects, pressurizing the chamber may comprise applying liquid or air to the membrane under pressure.

In some aspects, the liquid or the air may cool the formed orthodontic aligner.

In some aspects, the method may further comprise controlling a rate of cooling to effect desired functional property(ies) of the formed orthodontic aligner.

In some aspects, the dental model, the corresponding teeth digital model, and the formed orthodontic aligner may be of upper and lower arches of a patient's teeth.

In some aspects, the pre-cut aligner sheet may leave open one or more occlusal surfaces.

In yet further aspects, there is provided a method of forming an orthodontic aligner.

The method may comprise using a membrane to form a biocompatible thermoplastic sheet over a dental model.

In some aspects, the membrane is positioned between the biocompatible thermoplastic sheet and a pressurizable chamber.

In some aspects, the membrane provides a physical barrier between the biocompatible thermoplastic sheet and pressure applied in the pressurizable chamber.

In some aspects, the pressure applied in the pressurizable chamber is applied to the membrane, causing the membrane to form the biocompatible thermoplastic sheet over the dental model. As such, the biocompatible thermoplastic sheet may be perforated, since it is not required to be subjected to the pressure applied in the pressurizable chamber.

In some aspects, the biocompatible thermoplastic sheet may be heated prior to being formed over the dental model.

In some aspects, a material finish of the membrane may affect a surface finish of the formed orthodontic aligner.

In some aspects, stretching the membrane may alter the material finish of the membrane.

In some aspects, varying a stretch of the membrane may alter the surface finish of the formed orthodontic aligner.

In some aspects, altering the surface finish of the formed orthodontic aligner may comprise altering an opacity of the formed orthodontic aligner.

In some aspects, pressurizing the chamber may comprise applying liquid or air to the membrane under pressure.

In some aspects, the liquid or the air may cool the formed orthodontic aligner.

In some aspects, the membrane may be of a thickness and/or possess desired material properties (e.g., durometer, elasticity, functional operating temperature) suitable for developing the formed aligner.

In some aspects, the membrane has a tensile strength of about 650 psi to about 1300 psi.

In some aspects, the membrane has a tensile strength of about 650 psi.

In some aspects, the membrane has a tensile strength of about 700 psi.

In some aspects, the membrane has a tensile strength of about 1000 psi.

In some aspects, the membrane has a tensile strength of about 1200 psi.

In some aspects, the membrane has a tensile strength of about 1300 psi.

In some aspects, the membrane has a durometer of about 40 A to about 70 A.

In some aspects, the membrane has a durometer of about 40 A.

In some aspects, the membrane has a durometer of about 50 A.

In some aspects, the membrane has a durometer of about 60 A.

In some aspects, the membrane has a durometer of about 70 A.

In some aspects, the membrane has density of about 1.25 g/cm³ lbs/ft³.

In some aspects, the membrane has a tear strength of about 15 N/mm to about 17 N/mm.

In some aspects, the membrane has a tear strength of about 15 N/mm.

In some aspects, the membrane has a tear strength of about 17 N/mm.

In some aspects, the membrane has a compression set of about 0.20 to about 0.35.

In some aspects, the membrane has a compression set of about 0.20.

In some aspects, the membrane has a compression set of about 0.30.

In some aspects, the membrane has a compression set of about 0.35.

In some aspects, the membrane has a material temperature range of about −80° F. to about 500° F.

In some aspects, the membrane has a material temperature range of about −80° F. to about 450° F.

In some aspects, the membrane has a material temperature range of about −60° F. to about 400° F.

In some aspects, the membrane has a thickness of about 1/32″ to about ¼″.

In some aspects, the membrane is 1/32″ thick.

In some aspects, the membrane is 3/32″ thick.

In some aspects, the membrane is 1/16″ thick.

In some aspects, the membrane is ⅛″ thick.

In some aspects, the membrane is ¼″ thick.

In some aspects, the membrane comprises rubber.

In some aspects, the membrane comprises silicone rubber.

In some aspects, the membrane is food grade silicone rubber.

In some aspects, the membrane is fabric-reinforced grade silicone rubber.

In some aspects, the membrane is industrial grade silicone rubber.

In some aspects, the membrane comprises FDA silicone rubber, such as, for example, but not limited to, FDA silicone rubber available from Global Industrial.

In some aspects, the membrane comprises red FDA silicone rubber.

In some aspects, the membrane comprises semi-clear FDA silicone rubber.

In some aspects, the membrane comprises white FDA silicone rubber.

In some aspects, the membrane comprises 1/32″ thick, 60 A durometer, red FDA

silicone rubber.

In some aspects, the membrane is cut to fit forming rigs, such as, for example, but not limited to forming rigs provided by Biostar™.

In some aspects, the membrane comprises a thickness suitable for forming the biocompatible thermoplastic sheet over the dental model with enough specificity to capture occlusal topography.

In some aspects, the membrane comprises a thickness suitable for forming the biocompatible thermoplastic sheet over the dental model with enough specificity to capture occlusal topography while maintaining enough strength to resist splitting.

It will be appreciated that any of the above aspects may be combined or arranged in any suitable order or manner.

### BRIEF DESCRIPTION OF THE DRAWINGS

The present invention will be further understood from the following description with reference to the Figures, in which:

FIG. 1 depicts a flow diagram of an example method described herein;

FIG. 2 depicts another flow diagram of an example method described herein;

FIG. 3 depicts a partial view of an example apparatus described herein;

FIG. 4 depicts a side view of an example forming assembly described herein in an open configuration, with a sheet positioned beneath a heater;

FIG. 5 depicts a side view of the forming assembly shown in FIG. 4, in a closed configuration;

FIG. 6 depicts a schematic diagram of an example apparatus, computing device, database, and network described herein;

FIG. 7 depicts an example production process for creating dental aligners according to example aspects described herein;

FIG. 8A depicts an example heater over a thermoplastic sheet and model/pallet pair, according to example aspects described herein;

FIG. 8B depicts an example chamber and membrane over the example thermoplastic sheet and model/pallet pair shown in FIG. 8A;

FIG. 9 depicts a top view of an example apparatus described herein;

FIG. 10 depicts an upper perspective view of the example apparatus shown in FIG. 9;

FIG. 11 depicts a front view of the example apparatus shown in FIG. 9;

FIG. 12 depicts a right side view of the example apparatus shown in FIG. 9; and

FIG. 13 depicts an example model/pallet pair retention mechanism as described herein.

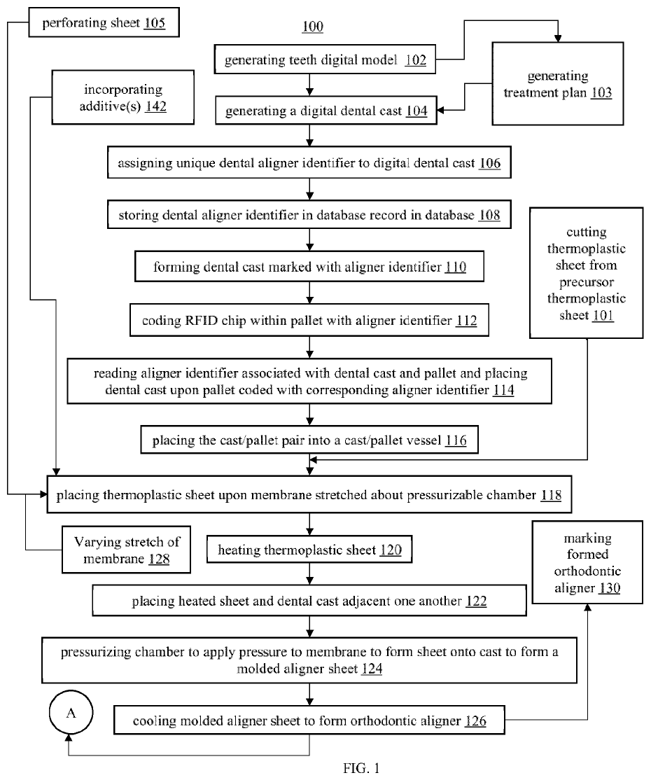

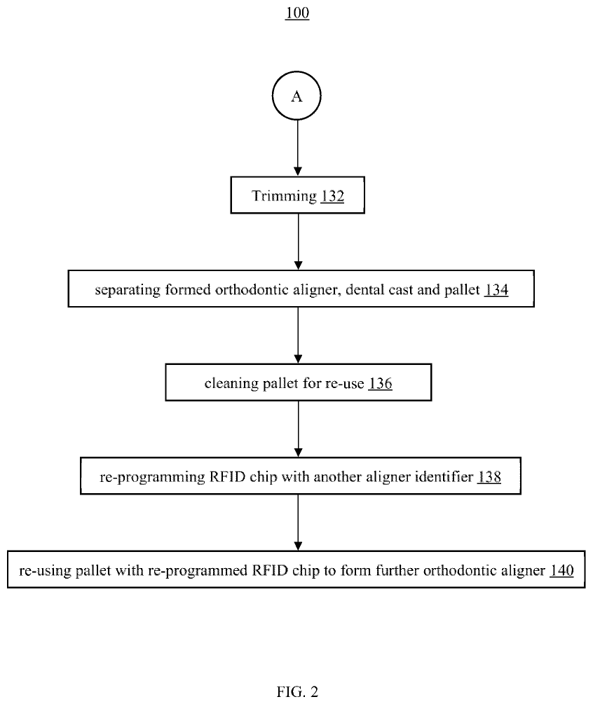

### DETAILED DESCRIPTION OF EXAMPLE EMBODIMENTS

The process of the present invention uses advanced computer imaging technology to take x-rays, intraoral scans and impressions of a patient's teeth, which are used to create a digital 3D image of the patient's mouth. Based on these images and impressions, a virtual treatment plan created specifically for that patient based on the patient's unique needs is mapped out using the Applicant's proprietary SureView™ software.

The Applicant's proprietary SureView™ software allows for a full visual simulation of the movement of the patient's teeth and projected treatment with each detail of tooth movement before the patient's treatment is started. Every planned and projected tooth movement is shown in detail. This 3D adjustable visual allows for the practitioner to see and manipulate treatment in a customized fashion in order to facilitate the best treatment for each and every patient as an individual. The SureView™ algorithm allows for precise calculation of tooth movements and tooth forces, which is expected to allow for improved treatment. Applicant's SureView™ proprietary software shows a complete digital journey of the treatment in the most minute of detail; from the first aligner to the last aligner. Once the treatment plan has been approved through the Applicant's SureView™ proprietary software, the Applicant's fabrication facility uses software to create a dental model using, such as, for example, but not limited to, rapid prototyping, such as, for example, but not limited to, 3D printing, based on the 3D form or scan data. The Applicant has the option to 3D print the upper and lower arches as separate dental models, or to 3D print the upper and lower arches as a single dental model. An identifying feature is then added to the model to personalize and sequence it, followed by cleaning the model.

Referring to the figures, in accordance with an aspect, there is provided a method 100 of forming an orthodontic aligner 10. In an aspect, the method 100 may comprise: (a) generating 102 a teeth digital model based on a three dimensional (3D) scan of a patient's teeth; (b) generating 104 a digital dental model based on the teeth digital model (e.g., the digital dental model may be shaped for a first desired alignment of the patient's teeth (to adjust alignment of the teeth by a first amount) out of a series of alignments for respective dental models in a treatment plan, to attain an ultimately desired alignment, as discussed further below); (c) assigning 106 a unique dental aligner identifier to the digital dental model and storing 108 the dental aligner identifier in a database record in a database 12, the database record containing information pertaining to the patient such that the information comprises the dental aligner identifier; (d) forming 110 a dental model 14 corresponding to the digital dental model, the dental model 14 marked with the aligner identifier corresponding to the digital dental model (such as by reading the digital dental model and the aligner identifier from the database 12 into a 3D printer, and accordingly 3D-printing the dental model with the aligner identifier thereon); (e) coding 112 a radio-frequency identifier (RFID) chip embedded within or otherwise physically associated with a pallet 16 with the aligner identifier; (f) reading 114 the aligner identifier associated with the dental model 14 and the pallet 16 and placing the dental model 14 upon the pallet 16 coded with the corresponding aligner identifier to form a model/pallet pair 18; (g) placing 116 the model/pallet pair 18 into a model/pallet vessel 20; (h) placing 118 a biocompatible thermoplastic sheet 22 upon a membrane 24 stretched about a pressurizable chamber 26, the thermoplastic sheet 22 sized and dimensioned sufficiently to be molded about the dental model and, in some aspects, smaller than the membrane 24; (i) heating 120 the thermoplastic sheet 22 with a heater 28 (which may comprise any suitable heater type, including an infrared (IR) heater 28) so as to make the sheet 22 sufficiently pliable to be molded about the dental model 14; (j) placing 122 the heated sheet 22 and the dental model 14 of the model/pallet pair 18 adjacent one another, such that the heated sheet 22 is adjacent, and may be in contact with, the dental model 14; (k) pressurizing 124 the chamber 26 to thereby apply pressure to the membrane 24 to form the sheet 22 onto the model 14 to form a molded aligner sheet 30; and (l) cooling 126 the molded aligner sheet 30 to form the orthodontic aligner 10.

In some aspects, the membrane 24 may be of a thickness and possess the desired material properties (e.g., durometer, elasticity, functional operating temperature) suitable for developing the formed aligner 10. In some tests, silicone rubber was used, cut to fit forming rigs (which may be of any suitable shape, such as the circular disk-shaped rigs provided by Biostar™, or square-shaped rigs, as examples only). In some tests, 1/32″ THK 60 Duro (+/−5) red FDA silicone rubber was used to form the membrane 24. A thickness of 1/32″ was found to be one suitable thickness, in that it provided a membrane 24 thin enough to capture occlusal topography (i.e., a thickness suitable for forming the biocompatible thermoplastic sheet 22 over the dental model 14 with enough specificity to capture occlusal topography) while maintaining enough strength to resist splitting.

The method 100 may further comprise generating 103 a treatment plan comprising a series of digitally simulated digital dental models from a first desired alignment digital dental model to a final desired alignment digital dental model, each of the series of digitally simulated digital dental models in the treatment plan shaped to incrementally progress the patient's teeth from a first desired alignment to a final desired alignment. The method 100 may then be carried out for each of the series of digitally simulated digital dental models in the treatment plan, with each of the series of digitally simulated digital dental models comprising a respective unique dental aligner identifier. In this way, the presently described aspects may be used to produce all aligners in a treatment plan for a particular patient and, as further described below, through detection and tracking of the aligner identifiers, such process may be automated, or substantially automated, for greater efficiency.

The membrane 24 may create a physical barrier between the sheet 22 and the pressure that is applied during the pressurizing 124 of the chamber 26, such that the applied pressure forms the membrane 24 onto the model 14 and the pallet 16, and the membrane 24 thereby effects the forming of the sheet 22 onto the model 14. In this way, it is expected that the aligner sheet 22 may be formed over the dental model 14 with less stretching of the sheet material 22 than with conventional aligner molding systems; i.e., since the aligner sheet 22 is already adjacent the dental model 14 (and may be in contact therewith) prior to the pressurizing 124 of the chamber 26, and is not in a pre-stretched state when placed adjacent the dental model 14, the aligner sheet 22 is not subjected to the extent of stretching that is applied to aligner sheet material in known aligner forming systems where the aligner sheet is pre-stretched and then pressurized to first be brought into contact with the dental model (a stretching step that is not required in the presently described aspects), and then further stretched to form the aligner sheet over the dental model. Since, in such prior art systems, the aligner sheet material is pre-stretched over the dental model, when the aligner sheet is subjected to pressure to effect the molding, the aligner sheet may also form over at least the pallet supporting the dental model, and possibly beyond the perimeter of the pallet, which results in wasted aligner sheet material that is required to be trimmed off in a downstream step. Furthermore, an advantage of the aligner sheet 22 of the presently described aspects not being the substrate that is pre-stretched over the dental model 14 is that the aligner sheet 22, when thermoformed over the dental model 14, will stretch to a lesser extent, and in some embodiments, in at least some portions of the formed aligner 10, not stretch at all, as compared to aligners formed by known systems. This is because the aligner sheet 22 of the presently described aspects may potentially only stretch or thin to some extent where it is trapped between the dental model 14 and the membrane 24, whereas other portions of the aligner sheet 22 would simply move, as pressure is applied to the membrane 24, toward and form over the dental model 14 without necessarily being stretched, or by stretching to a lesser extent than aligners formed by known systems. As such, as compared to aligners formed by known systems, the aligners 10 formed by the presently described aspects may have a more uniform thickness, which may result in improved aligner strength overall and/or in portions of the formed aligner 10, which in turn may result in an improved ability to move the patient's teeth to the desired alignment by the aligner 10.

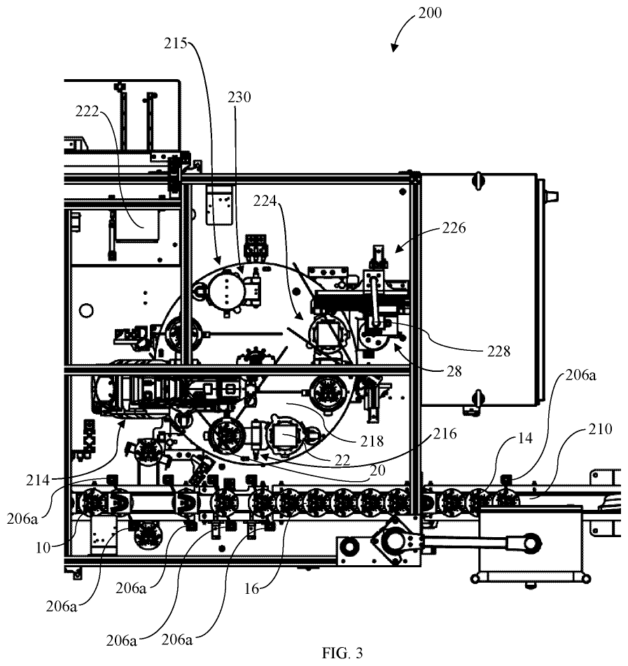

In some aspects, the method 100 may further comprise cutting 101 the biocompatible thermoplastic sheet 22 from a precursor thermoplastic sheet (which may take place at any time prior to placing 118 the thermoplastic sheet 22 upon the membrane 24 that is stretched about the pressurizable chamber 26). With the presently described aspects, since the membrane 24 acts as a physical barrier between the aligner sheet 22 and the applied pressure, it is the membrane 24 that is subjected to pressure to thereby form the aligner sheet 22 over the dental model 14, and so while the membrane 24, pre-stretched about the chamber 26, may form over the model 14 and the pallet 16, the aligner sheet 22 can be more efficiently sized when cut from a precursor thermoplastic sheet (for example, such that it molds over only the dental model 14). As such, the presently described aspects may eliminate or reduce the amount of downstream trimming required and resultant waste in order to produce the dental aligner. By use of the presently described aspects, there is expected to be a savings in precursor thermoplastic material, which may be ˜50% as compared to current dental aligner forming systems using thermoplastic discs (typically, 125 mm in diameter), since such discs serve as the physical substrate to be pressurized and as such, are required to be pre-stretched and clamped over the dental model to a ring seal, and thus must be cut large enough for such pre-stretching and clamping. With the presently described aspects, in which the membrane 24, rather than the aligner sheet 22, being pressurized, smaller aligner sheets 22 (e.g., 83 mm×90 mm sheets 22, as shown in the example embodiment depicted in FIG. 3) may be used, which allows for more efficient use of precursor thermoplastic material and reduced or, with improved cutting (such as determined by artificial intelligence and/or machine learning or otherwise), eliminated, downstream trimming. For example, in the example of 83 mm×90 mm sheets 22, if the precursor sheet material comprises a 250 mm disc (e.g., to form two 125 mm standard discs), three aligner sheets 22 could be formed from the 250 mm precursor sheet, instead of two, representing a savings in precursor sheet material of 50%. In the example embodiment shown, the 83 mm×90 mm sheet 22 comprises only ˜64% of the size of a standard 125 mm disk, which represents an improved efficiency in aligner sheet material usage.

Furthermore, since the presently described aspects do not require that the aligner sheet 22 be pressurized (and rather, the membrane 24, which forms a physical barrier between the sheet 22 and the applied pressure, is pressurized), the sheet 22 need not comprise a uniform, non-perforated substrate capable of being pressurized. As such, the method 100 may also comprise, at any suitable time prior to the placing 118 of the biocompatible thermoplastic sheet upon the membrane 24, perforating 105 the sheet 22 to, e.g., leave open areas on the sheet 22 that in the ultimately formed aligner 10 will align with some or all occlusal surfaces of the patient's teeth, which may lead to improved comfort for the patient (such as, e.g., the occlusal surfaces of opposing rear molars, where discomfort may otherwise result with traditional, unperforated dental aligners).

In some aspects, the cutting 101 may comprise using artificial intelligence and/or machine learning to optimize the cuts, in order to minimize wastage of the precursor thermoplastic sheet material.

During the course of testing, it was determined by the Applicant that a material finish of the membrane 24, which may be altered to different finishes by stretching the membrane 24 to different extents, affects a surface finish of the formed orthodontic aligner 10. As such, the method 100 may further comprise varying 128 a stretch of the membrane 24 to alter the surface finish of the formed orthodontic aligner 10. Varying 128 the stretch of the membrane 24 may comprise, e.g., varying the position of the membrane 24 about the chamber 26, such that pressurization of the chamber 26 and thus the membrane 24 results in more, or less, stretch of the membrane 24 before it contacts the aligner sheet 22 and forms the aligner sheet 22 about the dental model 14. Such varying of the stretch of the membrane 24 was found to alter the surface finish of the formed orthodontic aligner 10 by altering an opacity or clarity of the formed orthodontic aligner. Furthermore, the material finish of the membrane 24 may comprise images, shapes, pictures, and other graphics (such as star graphics for a child's aligner 10) that may be imparted to the formed orthodontic aligner 10 by the membrane 24 during the thermoforming process. Such graphics are required to be printed onto formed aligners in a post-thermoforming step in known dental aligner forming systems, which adds to cost, time and complexity.

The method 100 may in some embodiments further comprise marking 130 the formed orthodontic aligner 10 with the information or a portion of the information related to the aligner identifier for the formed orthodontic aligner 10. Such information, pertaining to the patient and which comprises the dental aligner identifier, may comprise any information pertaining to the patient or relevant to the treatment plan, such as a patient identifier, treatment plan and aligner identifier(s) with each aligner identifier in a treatment plan given a sequence number to identify the stage in the treatment plan when it is to be used, a start date and an end date indicating when to start and stop use of each aligner in a treatment plan, and the like. Any such information may be marked onto a formed aligner 10, such as by laser marking by a laser marking apparatus 202 that reads the aligner identifier from the RFID chip, queries the database 12 for the information related to the aligner identifier, and laser marks the information or the portion of the information onto the formed orthodontic aligner. If required, the method 100 may further comprise trimming 132 the formed orthodontic aligner 10 to remove excess of the molded aligner sheet. The trimming 132, which may be carried out by one or more trimmers 204 (each of which may comprise a CNC machine 204), may comprise reading the RFID associated with the pallet 16 for the formed aligner 10 to determine the aligner identifier (or reading the aligner identifier marked on the aligner 10 using a visual scanning device, if already marked at this stage), querying the database 12 and retrieving the digital dental model corresponding to the aligner identifier, and trimming 132 the formed orthodontic aligner 10 to substantially match the retrieved digital dental model so that the aligner 10 has an appropriate profile for use on a patient's teeth.

The method 100 may further comprise separating 134 the formed orthodontic aligner 10, the dental model 14 and the pallet 16, cleaning 136 the pallet 16 for re-use, re-programming 138 the RFID chip with another aligner identifier, and re-using 140 the pallet 16 (which may comprise another previously cleaned pallet 16 taken from a pool of previously cleaned pallets 16) and the reprogrammed RFID chip to form a further orthodontic aligner 10 according to aspects of the method 100 described herein.

In some aspects, the method 100 may further comprise, prior to the placing 118 the biocompatible thermoplastic sheet upon the membrane 24, incorporating 142 additive(s), such as biomarker(s) (such as by incorporating lateral flow assay (LFA) strip(s)), into the precursor thermoplastic sheet or the cut biocompatible thermoplastic sheet 22. In some aspects, each of the LFA strip(s) may comprise nanocrystals comprising biomarkers, which are expected to be ˜10 times more accurate than current biomarkers. It is expected that such incorporated biomarkers, which may be incorporated with an aligner 10 so as to be aligned, e.g., with the upper surface or dorsum of a patient's tongue, could be used in conjunction with a smart phone or a separate LFA analyzer to measure and detect small amounts of target analyte(s), which may help to identify certain diseases. Such additive(s) may also comprise, for example, antimicrobial agent(s), such as to treat canker sores, gingivitis, and other such treatable conditions in a patient's mouth.

In an aspect, each pallet 16 may comprise an aluminum top and a resin (such as Delrin™) base, and each RFID chip may be embedded within the base of each pallet 16. As described above, the encoded RFID chips may allow for tracking of each model/pallet pair 18 and associated formed aligner 10, which may facilitate automation of some or all of steps of method 100 described herein, such as by apparatus 200 shown in FIG. 3.

The apparatus 200 may comprise a conveyor 210 for inputting a queue of model/pallet pairs 18 (each pallet 16 having been paired by an operator who scanned the RFID chip to determine the aligner identifier and thereby identify the correct dental model 14 to place upon the pallet 16, or automatically by a robotic device that may read the RFID chip embedded within the pallet 16 to obtain the corresponding aligner identifier, and thereafter place the correct dental model 14 upon the pallet 16, in each case to form the model/pallet pair 18, such as at loading area 206 (which may comprise a camera and RFID reader 206a). Each pallet 16 may have been recycled for re-use, as described above with respect to the method steps of separating 134 the formed aligner 10 from the dental model 14 and the pallet 16, cleaning 136 the pallet 16 for re-use, re-programming 138 the RFID chip of the pallet 16 with another aligner identifier, and re-using 140 the pallet 16 with the reprogrammed RFID chip to form a further aligner 10. In some aspects, RFID readers 206a may be dispersed throughout the assembly line of the apparatus 200 (some examples of which are identified, e.g., in FIG. 3).

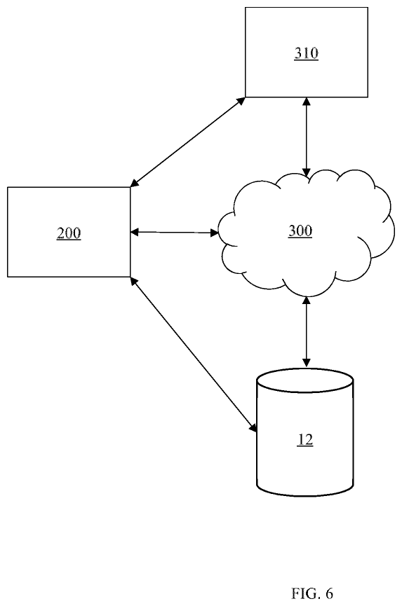

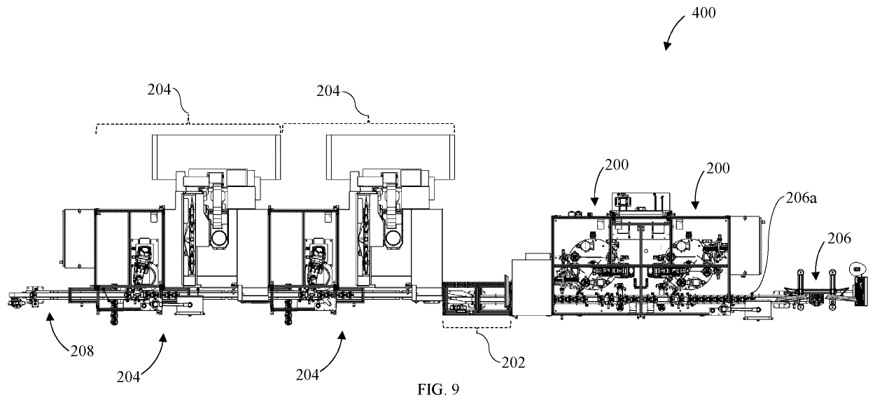

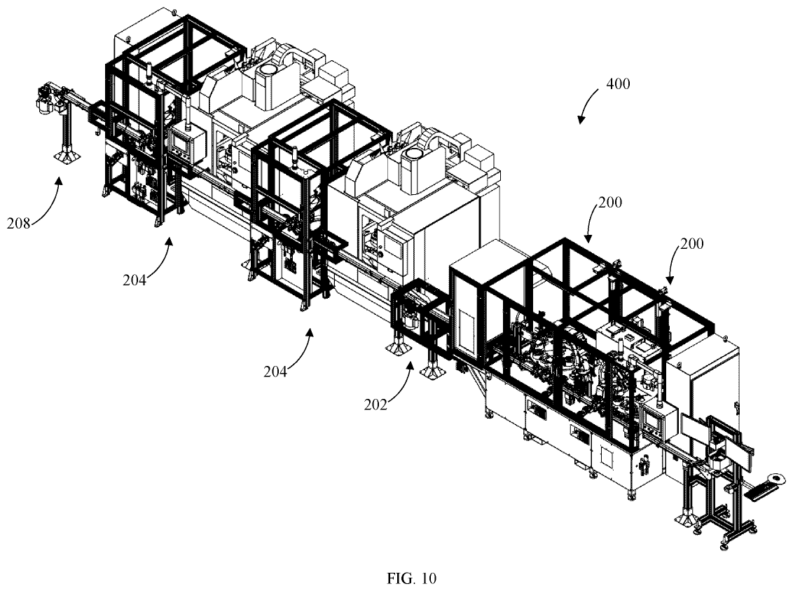

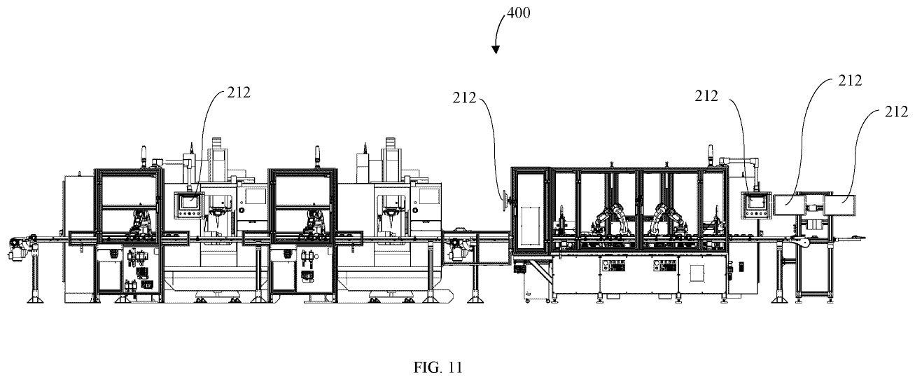

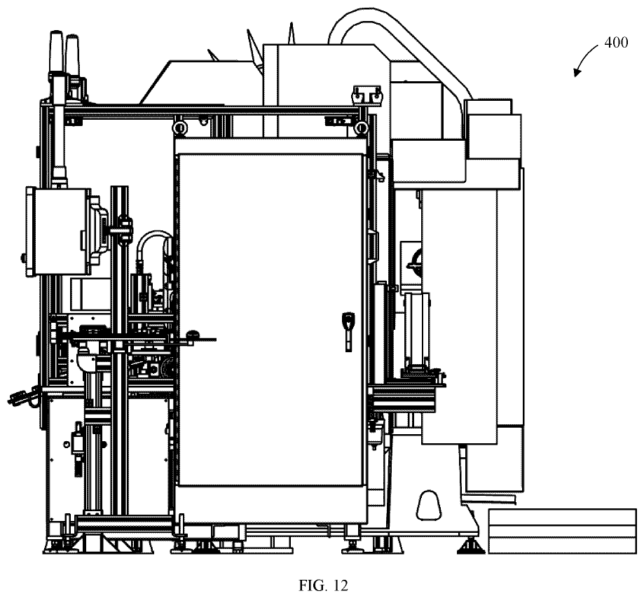

In some aspects, the apparatus 200, or a system 400 comprising one or more of the apparatus 200 (as shown, e.g., in FIGS. 9-12) (and which overall may be considered an apparatus 200), may further comprise a human-machine interface (HMI) 212 (which may comprise a plurality of HMIs 212, as shown, e.g., in FIG. 11), for operator control of components of the apparatus 200 and/or system 400, such as to start or stop any or all components of the apparatus 200/system 400, and/or to configure aspects of the apparatus 200/system 400 and/or connection of the apparatus 200 to external components, such as to the database 12 (such external components may comprise components of the system 400), as shown in FIG. 6. In some aspects, the HMI may comprise software or an app on a remote computing device 310 (such as a desktop computer or a smart phone) communicatively coupled to the apparatus 200 over one or more networks 300 of any suitable type, including the Internet. Such network-based connections may comprise suitable security features and components, such as firewalls and appropriate encryption protocols for improved security of the apparatus 200 and/or system 400 and any connected components. The apparatus 200 may also be communicatively coupled directly to the database 12 and/or the computing device 310, as also shown in FIG. 6. The database 12 may comprise a plurality of distributed databases, and the database 12 may be integrated with the apparatus 200 and/or system 400 as onboard storage as an alternative to, or in addition to, the communicative coupling of the apparatus 200 and/or system 400 to one or more remote databases 12 accessible over one or more networks 300.

As the conveyor 210 progresses the queue of model/pallet pairs 18, a robotic arm 214 moves a model/pallet pair 18 from the conveyor 210 to a forming assembly 215 positioned at a loading station 216 of a dial 218. Each forming assembly 215 may comprise a model/pallet vessel 20 that is sized for receipt of a pallet 16 therein or thereon and which is hingedly connected to a chamber 26 via a hinge 220, such that the chamber can be pivoted about the hinge 220 to close the chamber overtop of the vessel 20 (or vice versa). A membrane 24 is stretched about the chamber 26 (and may be clamped or attached to a ring seal formed around a perimeter of the chamber 26) and the chamber 26 is capable of connection to an air or liquid supply for supply of air or liquid pressure thereto, in order to apply pressure to the membrane 24, as further described below. The membrane 24 may comprise a non-stick and reusable material. In some aspects, the membrane 24 may be replaceable, which may be required where the membrane 24 becomes worn after repeated use and stretching; such replacement may be effected, e.g., by removing the stretched membrane 24 along with the ring seal to which it is attached, and replacing the removed membrane 24 and ring seal with another pre-stretched membrane 24 and ring seal. Alternatively, the membrane 24 may be detached from the chamber and if applicable, ring seal, and then a replacement membrane 24 may be attached thereto.

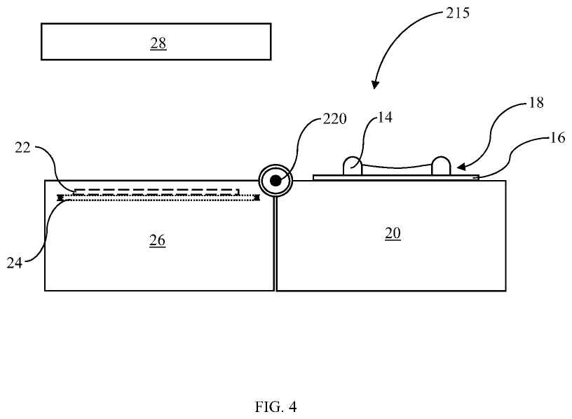

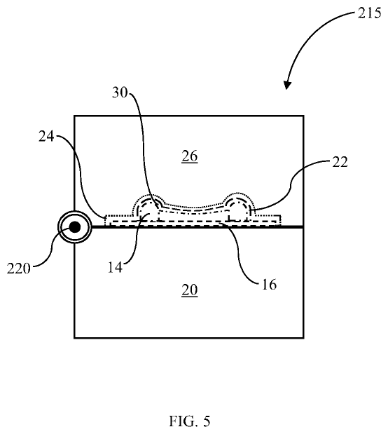

Once a model/pallet pair 18 is transitioned to the loading station 216, the robotic arm 214 obtains, and places on the pre-stretched membrane 24, an aligner sheet 22 from an aligner sheet supply section 222. The dial 218 is then automatically rotated, e.g. counter-clockwise, to position the forming assembly 215 at a thermoforming station 224 where a robotic assembly 226, which comprises the heater 28, positions the heater 28 overtop the aligner sheet 22 (as shown in FIG. 4) to heat the aligner sheet 22 so as to make the sheet 22 sufficiently pliable to be molded about the dental model 14 (the temperature or range of temperatures required to achieve such pliability depends on the material used for the aligner sheet 22, but is typically ˜220° C. for 30-45 seconds). The robotic assembly 226 may comprise a translatable and/or pivotable second robotic arm 228 comprising the heater 28, such that when the forming assembly 215 is positioned at the heating station 224, the heater 28 is moved into place overtop the aligner sheet 22. Alternatively, the heater 28 may be stationary overtop the thermoforming station 224. Once the aligner sheet 22 is sufficiently heated, as described above, the robotic assembly 226, such as by the second robotic arm 228, flips or pivots the chamber 26 overtop the model/pallet vessel 20 (or vice versa, in other aspects) about the hinged connection therebetween (as shown in FIG. 5) and connects the chamber 26 to the air or liquid supply for supply of air or liquid under pressure (e.g., about 90 psi to about 130 psi) to the chamber 26, in order to apply pressure to the membrane 24 to form the aligner sheet 22 over the dental model 14, as described above.

In other aspects, and where appropriate (e.g., where the aligner sheet 22 is not perforated), a negative pressure may be applied to the chamber 26 so as to suck the aligner sheet 22 onto the dental model 14, in addition to, or as an alternative to, the positive pressure (described above) applied over the membrane 24.

The dial 218 is then automatically rotated and transitions the forming assembly 215 to a cooling station 230, where the molded aligner sheet 30 cools to a suitable temperature (e.g., room temperature) for firming or solidifying the molded aligner sheet 30 to form the formed aligner 10. Cooling may occur passively, or to facilitate cooling, a coolant (either liquid or air) may be fed into the chamber 26, thereby altering the cooling rate of the aligner material. The applied liquid or air can thus both cool and apply pressure to the molded aligner sheet 30 to help maintain the molded form of the aligner during the cooling process, to form the formed aligner 10. In this way, the rate of cooling may be controlled by altering the coolant type (a liquid coolant, such as water, is expected to absorb heat with greater efficiency than air), temperature, or rate of application. Thereafter, the dial 218 is automatically rotated to transition the forming assembly 215 back toward the robotic arm 214, which grasps and moves the forming assembly 215 to an exiting portion of the conveyor 210, where the above-described further steps of marking 130 the formed orthodontic aligner 10, trimming 132, separating 134 the formed orthodontic aligner 10, dental model 14 and pallet 16, cleaning 136 the pallet 16 for re-use, and re-programming 138 the RFID chip with another aligner identifier, may take place as further downstream steps, either in an automated fashion by way of further robotic components, and/or manually by an operator. For example, as depicted in the example system 400 shown in FIGS. 9-12, once the robotic arm 214 grasps and moves the forming assembly 215 to an exiting portion of the conveyor 210, the forming assembly may then be moved to the laser marking apparatus 202 for marking of the formed aligner 10, and then to a trimmer 204 for trimming of the formed aligner 10, before the former aligner is, for example, moved to an unloading area 208 (or, alternatively, moved to further downstream stations which may comprise automated processes).

In some aspects, the apparatus 200 may be alternatively arranged such that the dial 218 progresses the forming assembly 215 clockwise, or the apparatus 200 may not comprise a dial 218, but instead transition the forming assembly 215 through the various stages described above in some other fashion, such as linearly.

In some aspects, the aligner sheets 22 may be cut to match or substantially match a 2D representation of the corresponding 3D digital dental model, so as to improve efficiency of aligner sheet usage even further.

Further, in some aspects, one or more of the apparatus 200 may comprise part of a system 400, such as the example system 400 shown in FIGS. 9-12, which includes two of the apparatus 200 and two of the trimmers 204, for increased throughput of the formed aligners 10. Further systems 400 may comprise yet other arrangements of the various components described herein. As used herein, a system 400 may be considered an apparatus 200, and vice versa.

In accordance with some aspects, each pallet 16 may comprise locating features which may correspond to locating features on the corresponding dental models 14 (e.g., such locating features may be shaped to form a male/female releasable connection therebetween) to facilitate automated alignment of the dental models 14 upon respective pallets 16.

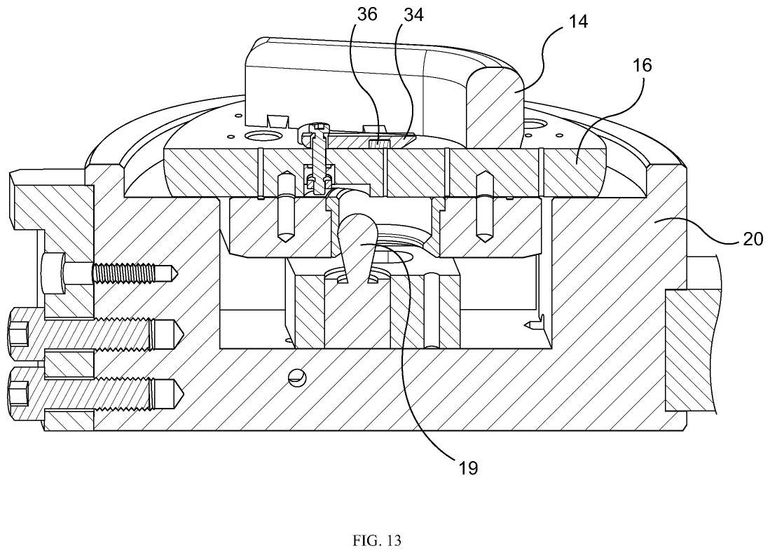

With reference to FIG. 13, in some aspects, a model/pallet pair retention mechanism 19 may facilitate retention of a model/pallet pair 18 as it is flipped overtop a heated sheet 22 and dental model 14, as shown, e.g., in FIG. 5. The model/pallet pair retention mechanism 19 may comprise, e.g., a spring-loaded pin 19 releasably received within the pallet 16. During forming, if there is enough of the sheet 22, the sheet 22 may form into the pallet 16 and thereby hold the dental model 14 in place. In some aspects, in order to retain the dental model 14 upon the pallet 16, in aspects where the model/pallet pair 18 is flipped overtop the heated sheet 22 and dental model 14, a clip 34 on the pallet 16 may clamp or otherwise retain the dental model 14 on the pallet 16. For example, the dental model 14 may be formed with a bar or cross-member 36 positioned for releasable receipt under the clip 34, as shown in FIG. 13 (which represents one example aspect for retaining a dental model 14 against a pallet 16). FIG. 13 depicts an example mechanism for retaining a pallet 16 and dental model arch 14 in place as the lid is flipped.

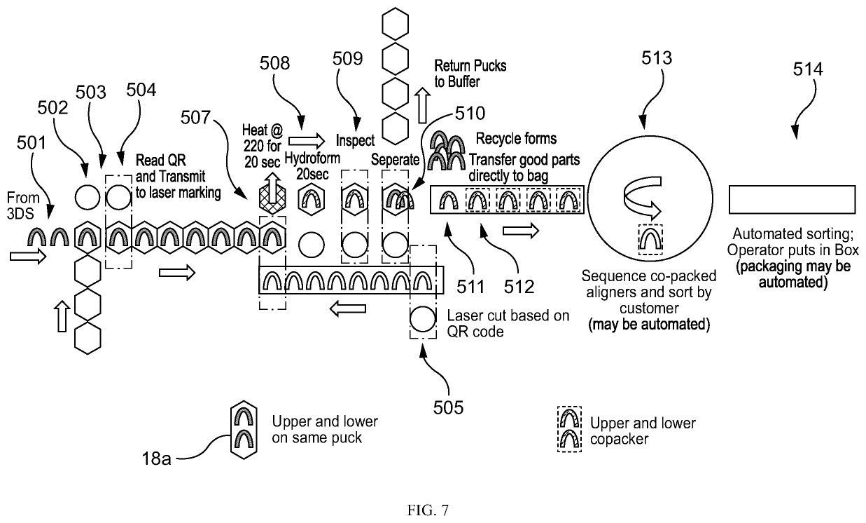

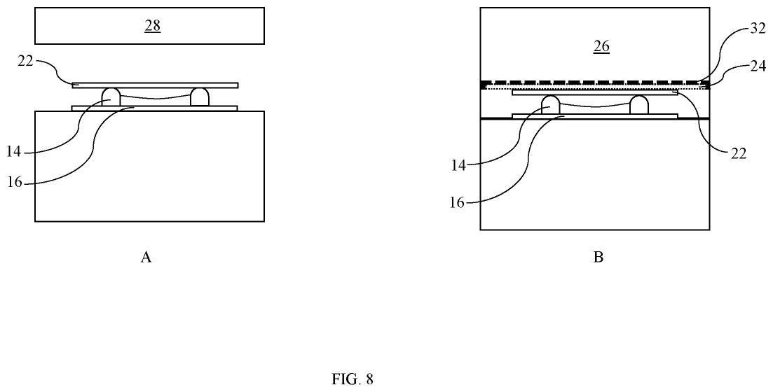

Referring to FIGS. 7 and 8, in an embodiment of the present invention, a process comprises the following steps to prepare an aligner 10:
1. Starting 501 the forming process.
2. Placing 502, 114 the 3D form or dental model 14 on a transfer puck or pallet 16 (the pucks 16 may be identical and may each comprise features for aligning with corresponding locating features on respective dental models 14, as described above).
3. Introducing 503 the puck 16 to a buffer queue.
4. Identifying 504 the 3D form or dental model 14 entering the queue by reference to the unique aligner identifier assigned 106 to the dental model 14 in the database 12.
5. Cutting 505, 101 the blank aligner profile (and as described above, optimizing the cut pattern may minimize waste, such as by cutting the sheets 22 from the precursor thermoplastic sheets only to the size necessary, as may be determined by AI/ML, and which may comprise cutting 505, 101 the sheets 22 to match or substantially match a 2D representation of the corresponding 3D digital dental model, so as to improve efficiency of aligner sheet usage even further, as also described above).
6. Sequencing 506 the blank profiles or cut sheets 22 (such as may be required where the blank sheets 22 have been cut from the precursor thermoplastic sheet to match or substantially match a 2D representation of the corresponding 3D digital dental model, as described above, and/or as may be required to match sheets 22 cut for upper and lower arches of a patient, where a pair of the cut sheets 22 for corresponding upper and lower arches are placed on a single pallet 16, as shown at the model/pallet pair 18b shown in FIG. 7) and positioning over the correct, corresponding 3D printed forms or dental models 14.
7. Heating 507, 120 the blank profile or sheet 22 to achieve a desired ductility.
8. Applying pressure 508 by hydro-forming the blank profile or sheet 22 over the 3D printed forms or dental models 14, and holding the molded sheet 22 in place while cooling the molded sheet 22, such as by the application of the liquid, to form the formed aligner 10.
9. Inspecting 509 the formed aligner 10.
10. Separating 510 the formed aligner 10 from the form or dental model 14.
11. Cleaning 511 the formed aligner 10 (which step may be optional).
12. Transferring 512 a pair of formed aligners 10 (for the upper and lower arches for a patient) directly to packaging.
13. Sorting 513 the transferred pairs of formed aligners 10 to complete a treatment plan for the patient.
14. Labelling, packing and completing 514 the order.

In another aspect, the process includes the following steps to prepare the aligner 10:
1. Starting 501 the forming process.
2. Affixing or placing 502, 114 the 3D arch or dental model 14 on a transfer puck or pallet 16 (the pucks 16 may be identical and may each comprise features for aligning with corresponding locating features on respective dental models 14, as described above). Each pallet 16 may further comprise backing features to facilitate maintaining a dental model 14 thereon, such as by increased frictional engagement between the pallet 16 and the dental model 14 as caused by such backing features (which may include, e.g., bumps or ribbing to effect such frictional engagement).
3. Introducing 503 the puck 16 to a buffer queue.
4. Identifying 504 the 3D arch or dental model 14 entering the queue by reference to the unique aligner identifier assigned 106 to the dental model 14 in the database 12.
5. Cutting 505, 101 the blank aligner profile (and as described above, optimizing the cut pattern may minimize waste, such as by cutting the sheets 22 from the precursor thermoplastic sheets only to the size necessary, as may be determined by AI/ML, and which may comprise cutting 505, 101 the sheets 22 to match or substantially match a 2D representation of the corresponding 3D digital dental model, so as to improve efficiency of aligner sheet usage even further, as also described above).
6. Sequencing 506 the blank profiles or cut sheets 22 (such as may be required where the blank sheets 22 have been cut from the precursor thermoplastic sheet to match or substantially match a 2D representation of the corresponding 3D digital dental model, as described above, and/or as may be required to match sheets 22 cut for upper and lower arches of a patient, where a pair of the cut sheets 22 for corresponding upper and lower arches are placed on a single pallet 16, as shown at the model/pallet pair 18a shown in FIG. 7) and placing on the membrane (also known as a “bladder”) 24. A cavity below the membrane (bladder) 24 may have a pressure just below atmospheric pressure in order to keep the aligner sheet 22 and membrane (bladder) 24 from deforming during the heating and downstream process.
   a. In some aspects, the membrane (bladder) 24 may be of a correct thickness and possess desired material properties (e.g., durometer, elasticity, functional operating temperature). In a non-limiting embodiment used in development and testing of the aspects described herein, the membrane (bladder) 24 was silicone rubber cut to fit into the existing Biostar™ forming rigs (1 piece of 1/32″ THK 60 Duro (+/−5) Red FDA Silicone Rubber×36″ Wide×2 Feet long roll).
   b. Based on the testing, and as noted above, it was observed that, in some aspects, the material finish of the membrane (bladder) 24 alters with the amount of stretch of the membrane 24 and that the finish is transferred to the formed aligner 10, at the point of contact between the membrane 24 and the aligner sheet 22/formed aligner 10, which may affect the opacity of the formed aligner 10. It was determined that the quality of the surface finish of the membrane (bladder) 24 could be controlled by controlling the amount of stretch of the membrane (bladder) 24. Controlling the membrane stretch, such as by computer-implemented instructions (such as the Applicant's SureSecure™ technology), provides the ability to customize the opacity and clarity of the formed aligner 10, by such an algorithm, to a patient's or dental professional's preference. The surface texture of the membrane/bladder 24 at the point of contact with the aligner sheet 22 may comprise an inherent property of the membrane material, and as noted above, may also be controlled by the distance of the membrane 24 from the dental model 14 (i.e., the amount of stretching of the membrane 24 required to shape the aligner sheet 22 over the dental model 14).
7. Heating 507, 120 the blank profile or cut sheet 22 to achieve a desired ductility (as noted above, this is based on the material used for the aligner sheet 22, but such heating is typically at ˜220° C. for about 30-45 seconds).
8. Lowering the properly aligned 3D printed arches(s) or dental model(s) 14 onto the aligner sheet(s) 22 and membrane (bladder) 24 using either a press or a robotic arm (such as the robotic assembly 226, e.g., the second robotic arm 228 thereof, as described above), and locking a backing plate thereover (such as via the robotic assembly 226, e.g., the second robotic arm 228 thereof).
   a. Applying pressure 508 in the cavity below the membrane (bladder) 24 up to, e.g., 90 Psi, and holding the sheet 22 in place while cooling the molded sheet 22 to form the formed aligner 10. Cooling may occur naturally, by the gradual loss of heat to the ambient environment, and/or forced (such as described above with respect to liquid cooling) to increase the cooling rate, and/or to alter the functional properties of the aligner 10 through varied cooling rates.
9. Laser marking 130 the formed orthodontic aligner 10 (such as with a company and patient ID, and/or as described above).
10. Trimming 132 any excess aligner material, such as via the trimmer(s) 204.
11. Separating 510 the formed and trimmed aligner 10 from the arch or dental model 14.
12. Grinding and polishing the separated formed aligner 10, such as in a tumbler (not shown).
13. Cleaning 511 the formed aligner 10 (which step may be optional).
14. Transferring 512 a pair of formed aligners 10 (for the upper and lower arches for a patient) directly to packaging.
15. Sorting 513 the transferred pairs of formed aligners 10 to complete a treatment plan for the patient.
16. Labelling, packing and completing 514 the order.

In an embodiment of the present invention, the dental aligners 10 are prepared from a high-calibre biocompatible plastic such as Zendura FLX™ provided by Bay Materials LLC, 48450 Lakeview Blvd., Fremont, CA 94538. The clear custom plastic aligners 10 of the present invention fabricated from Zendura FLX™ have an elastomeric middle layer that provides stronger tooth-moving forces over time than possible with standard thermoplastics. The clear custom plastic aligners of the present invention fabricated from Zendura FLX™ are completely clear, resistant to cracks and stains, and are more comfortable to wear at first compared to other brands.

In some aspects, such as where the aligner sheets 22 are cut to match or substantially match a 2D representation of the corresponding 3D digital dental model, the dental aligners 10 may be prepared using pre-cut aligner sheets 22. As discussed above, a digital model of the original alignment of the teeth is obtained and a treatment plan may then be created 103, comprising a series of teeth digital models of the teeth at different stages of alignment between the original alignment and a desired alignment. A series of dental models 14 may be made 110, each corresponding to each of the teeth digital models in the treatment plan. For each of the teeth digital models, a virtual edge of a three-dimensional (3D) aligner corresponding to each of the teeth digital models can be defined. This can be done by defining a line that is displaced below a gingival line of the teeth digital model around the teeth digital model. The displacement may be 2 mm or as otherwise desired. The virtual edge and teeth digital model above the virtual edge thus define a 3D shape of the aligner. The 3D shape is computationally converted into a developed surface having a two-dimensional (2D) shape corresponding to the 3D shape. This may be performed using an appropriate surface development algorithm that maps the virtual edge into a perimeter of a 2D developed surface.

The 2D shape may then be cut 101, 505 from a biocompatible thermoplastic sheet (which may be translucent) to form a pre-cut aligner sheet 22. When the pre-cut aligner sheet 22 is thermoformed 124, 508 over the dental model 14 of the corresponding teeth digital model, the 3D aligner 10 is formed having an aligner edge that corresponds to the virtual edge defined using the teeth digital model, as described above. This eliminates the need for a further trimming step to be performed on the thermoformed aligner 10 as no excess material extends beyond the desired aligner edge. In contrast, in the current state of the art method where a thermoplastic aligner sheet that is significantly larger than the aligner model 14 and pre-stretched and thermoformed over the dental model 14, trimming away of the excess material that extends beyond the desired aligner edge is needed in order to form the actual aligner. Removing the trimming step (or at least reducing the extent of trimming 132 required, such as described above), may save time and cost.

In some aspects, to effectively thermoform 124, 508 the pre-cut aligner sheet 22 over the dental model 14, a membrane 24 or bladder 24 may be used under the pre-cut aligner sheet 22 to create the vacuum seal around the dental model 14, as described above. With reference to FIG. 8, in an aspect, during thermoforming 124, 508, the pre-cut aligner sheet 22 is first held in place under the membrane or bladder 24. The dental model 14 is then pulled down (as described above) onto the pre-cut aligner sheet 22 with the membrane or bladder 24 underneath using vacuum pressure in order for the pre-cut aligner sheet 22 to take the shape of the dental model 14 under heat. The membrane or bladder 24 is preferably pliable and of a non-stick material in order to be readily released from the thermoformed aligner 10 and reusable over multiple cycles, as described above.

The present invention aims to optimize use of capital equipment and process materials and includes, e.g., the following steps and expected advantages for some of the aspects described herein:
1) The present invention, in some aspects, minimizes the size of the 3D forms which saves raw material and reduces the time to print the forms, by approximately 30% in an embodiment.
2) The present invention, in some aspects, makes use of the digital model of the 3D printed arch to develop the aligner sheet 22, or even where the sheets 22 are not cut to match or substantially match a 2D representation of the corresponding 3D digital dental model 14, the presently described aspects all for use smaller sheets 22 given that the sheets 22 are not required to be stretched prior to thermoforming onto the dental models 14, to minimize waste.
3) The present invention precuts the aligner sheets 22 (such as, for example, but not limited to, modified polyurethane that is about 0.030″ thick) to minimize the amount of raw material required by approximately 70% in some aspects. The use of precut aligner sheets 22 in the process of the present invention eliminates the need to trim, or at least reduces the amount of trimming of, the aligners to remove the excess form or precursor material and thus, minimizes the amount of trim waste generated from the aligners from the excess form or precursor material. In some aspects, the paired aligners produced by the present invention can then be easily packed and identified. The current state of the art process of trimming is typically done using a 5-axis cutting mill or alternatively by laser or water cutting. This trimming process results in process waste and typically leaves sharp edges that need to be removed by a downstream process. By eliminating the trimming in some aspects (such as where the sheets 22 are cut to match or substantially match a 2D representation of the corresponding 3D digital dental model 14), the process of the present invention may also eliminate the need for bulk deburring and polishing. The current state of the art of deburring makes it impossible to sequence the aligners and means that they need to be tracked and sorted and cleaned.
4) As shown, e.g., by the model/pallet pair 18b shown in FIG. 7, the present invention may form the aligner sheets 22 in pairs (upper and lower arches of a patient's teeth) placed on a single pallet 16, and in some aspects, nested, so that the dental aligners 10 for both the upper and lower arches may be produced in the same production cycle, which provides double the output and reduces the amount of sorting and tracking required.
5) By changing the stretch of the membrane 24, the present invention may alter the surface finish of the resulting aligner 10 (as described above).
6) In the process of the present invention, since the aligner sheet 22 is not constrained by an outer ring during the forming process, the amount of aligner stretch during forming can be greatly reduced. This results in a more consistent thickness across the cross section of the formed aligner 10, which may provide more consistent functional properties, as described above. As such, the presently described aspects may provide an opportunity (if desired) to reduce the material thickness due to the elimination or minimizing of localized thinning in the formed dental aligners 10.
7) The membrane 24 of the present invention is a physical barrier and acts on the cut aligner sheet 22 independent of the aligner sheet's shape. The present invention provides an opportunity to create impressions and clearances within occlusal areas of the molars, making the aligners 10 more comfortable to wear, as described above. In known thermoforming systems, sheets to be molded are pre-stretched, heated and then subjected to pressure to be formed over molds, which requires that the sheet be continuous and unperforated. In embodiments of the presently described subject-matter, the membrane 24, acting as a physical barrier, isolates the pressurized chamber 26 from the dental model 14, such that the aligner sheet 22 to be molded can be cut out (e.g., to form the pre-cut aligner sheet 22) and/or be perforated in such a way as to leave open occlusal surfaces, as described above.
8) Since the membrane 24 of the present invention is a physical barrier, the process of the present invention allows for forced cooling (by either air or liquid). For example, coolant (air or liquid) may be run through the chamber 26, and the coolant may also apply the forming pressure onto the membrane 24. In some aspects, a negative pressure, which may be slight, may be applied to the membrane 24 to help keep the membrane flat prior to a positive pressure being applied to the membrane 24 (such as by pressurizing a liquid or air chamber 26), once the dental model 14 and corresponding pallet 16 are in place, ready for the aligner sheet 22 to be molded thereupon. In some embodiments, cooling rates may be altered, and it is expected that through varying cooling rates, controllable by a user, as described above, the present invention may permit for the control of resulting localized structures and/or the imparting of desired functional property(ies) to the formed orthodontic aligner 10.
9) Since the membrane 24 of the present invention is a physical barrier and the aligner 22 may be positioned adjacent the membrane 24, additional materials and compounds that will bond or imbed to the aligner sheet 22 may be introduced during the forming process, and/or at other times, as described above. These additional materials and compounds could be organic or inorganic and be used to extend the application of the aligner, such as for compliance tracking or health monitoring purposes. For example, as described above, lateral flow assay (LFA) strips may be incorporated into the aligner sheets 22, or into a retainer tray structure, such as in the form of embedded biomarkers with nanocrystals to create an LFA matrix that is expected to be highly sensitive. It is expected that this would permit the detection of various disease states, and the evaluation of and screening for multiple diseases using the embedded LFA strip(s)/matrix, depending on the biomarker(s) chosen.
10) For certain applications, the present invention may provide the opportunity to reduce material costs even further by using an injection molded aligner material that is preformed to a standard shape. This can only be processed using the Applicant's proprietary SureForm™ process or algorithm. In addition, the “additional materials and compounds” mentioned in item 9) above may also be introduced into the extrusion.

In some aspects (such as, e.g., aspects involving a pre-cut aligner sheet 22 that matches or substantially matches a 2D shape derived from a corresponding 3D digital dental model, or where water cooling is used), a rigid porous backing plate 32 (as shown, e.g., in FIG. 8B) may provide a reference plane against which the membrane 24 is held by way of a negative pressure, so that prior to the application of a positive pressure to the membrane 24 to effect the thermoforming of the aligner sheet 22, the position of the membrane 24 may be controlled and the membrane 24 may be substantially flattened for a more effective thermoforming process.

In aspects involving a pre-cut aligner sheet 22 that matches or substantially matches a 2D shape derived from a corresponding 3D digital dental model, the apparatus 200 may not comprise a dial 218; rather, a model/pallet pair 18 may remain on the conveyor 210, and the robotic arm 214 may, through a scanning device and software, locate the appropriate pre-cut aligner sheet 22 (which may be marked with the corresponding aligner identifier, such as by laser marking, in an earlier step), and precisely position the aligner sheet 22 over the dental model 14 for the thermoforming process to continue.

Generally, in some of the aspects described herein, each pre-cut aligner sheet 22 is based on a patient's specific teeth scan (after having been converted to a 2D shape), as is the corresponding dental model 14, and so each pre-cut aligner sheet 22 corresponds to a specific, corresponding dental model 14 (which may comprise a 3D-printed form), and in other aspects described herein, the sheet 22 profiles may all be the same, and so are simply positioned over the next dental model 14 in the queue rather than requiring placement upon a specific dental model 14 with the same aligner identifier (as described above). It will be appreciated that any of the aspects described herein are expected to result in more efficient use of precursor thermoplastic sheets since 1) the cut aligner sheets 22 are not required to be pre-stretched and pressurized to effect the thermoforming and so may be cut smaller than known aligner sheets, and 2) the aligner sheets 22 may be cut even smaller where they match or substantially match a 2D shape derived from a corresponding 3D digital dental model.

The above description is that of embodiments of the present invention. Various alterations and changes can be made without departing from the scope and broader aspects of the invention as set forth in the appended claims, which are to be interpreted in accordance with the principles of patent law. Furthermore, while particular orders of method steps have been described herein and shown in the drawings, it will be appreciated that any of the method steps described herein may be carried out in any other suitable order. Furthermore, it will be appreciated that any of the aspects described herein may be optional (whether indicated herein as being optional or not) if their omission would not prevent any of the various aspects described herein from being achieved.

Unless otherwise explained, all technical terms used herein have the same meaning as commonly understood by one of ordinary skill in the art to which this disclosure belongs. Although any methods and materials similar or equivalent to those described herein can be used in the practice for testing of the present invention, the typical materials and methods are described herein.

It is also to be understood that the terminology used herein is for the purpose of describing particular aspects only and is not intended to be limiting. Any patent applications, patents, and publications cited herein are to assist in understanding the aspects described. All such references cited herein are incorporated herein by reference in their entirety and for all purposes to the same extent as if each individual publication or patent or patent application was specifically and individually indicated to be incorporated by reference in its entirety for all purposes. To the extent publications and patents or patent applications incorporated by reference contradict the disclosure contained in the specification, the specification is intended to supersede and/or take precedence over any such contradictory material.

In understanding the scope of the present application, the articles “a”, “an”, “the”, and “said” are intended to mean that there are one or more of the elements. Additionally, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

It will be understood that any aspects described as “comprising” certain components may also “consist of” or “consist essentially of,” wherein “consisting of” has a closed-ended or restrictive meaning and “consisting essentially of” means including the components specified but excluding other components except for materials present as impurities, unavoidable materials present as a result of processes used to provide the components, and components added for a purpose other than achieving the technical effect of the invention.

It will be understood that any component defined herein as being included may be explicitly excluded from the claimed invention by way of proviso or negative limitation.

In addition, all ranges given herein include the end of the ranges and also any intermediate range points, whether explicitly stated or not.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The abbreviation, “e.g.” is derived from the Latin exempli gratia, and is used herein to indicate a non-limiting example. Thus, the abbreviation “e.g.” is synonymous with the term “for example.” The word “or” is intended to include “and” unless the context clearly indicates otherwise.

What is claimed is:

1. A method of forming an orthodontic aligner, the method comprising:
(a) generating a teeth digital model based on a three dimensional (3D) scan of a patient's teeth;
(b) generating a digital dental model based on the teeth digital model;
(c) assigning a unique dental aligner identifier to the digital dental model and storing the dental aligner identifier in a database record in a database, the database record containing information pertaining to the patient such that the information comprises the dental aligner identifier;
(d) forming a dental model corresponding to the digital dental model, the dental model marked with the aligner identifier corresponding to the digital dental model;
(e) coding a radio-frequency identifier (RFID) chip physically associated with a pallet with the aligner identifier;
(f) reading the aligner identifier associated with the dental model and the pallet and placing the dental model upon the pallet coded with the corresponding aligner identifier to form a model/pallet pair;
(g) placing a biocompatible thermoplastic sheet upon a membrane stretched about a pressurizable chamber;
(h) heating the thermoplastic sheet with a heater so as to make the sheet sufficiently pliable to be molded about the dental model;
(i) placing the heated sheet and the dental model of the model/pallet pair adjacent one another;
(j) pressurizing the chamber to thereby apply pressure to the membrane to form the sheet onto the model to form a molded aligner sheet; and
(k) cooling the molded aligner sheet to form the orthodontic aligner;
wherein the membrane creates a physical barrier between the applied pressure and the sheet such that the applied pressure forms the membrane onto the model and the pallet and the membrane thereby effects the forming of the sheet onto the model.

2. The method of claim 1, wherein the membrane comprises a non-stick and reusable material.

3. The method of claim 1, further comprising generating a treatment plan comprising a series of digitally simulated digital dental models from a first desired alignment digital dental model to a final desired alignment digital dental model, wherein the method is carried out for each of the series of digitally simulated digital dental models in the treatment plan, each of the series of digitally simulated digital dental models comprising a respective said unique dental aligner identifier.

4. The method of claim 1 wherein a material finish of the membrane affects a surface finish of the formed orthodontic aligner, stretching the membrane altering the material finish of the membrane.

5. The method of claim 4 further comprising varying a stretch of the membrane to alter the surface finish of the formed orthodontic aligner.

6. The method of claim 5 wherein said alter the surface finish of the formed orthodontic aligner comprises altering an opacity of the formed orthodontic aligner.

7. The method of claim 1 further comprising, prior to the placing the biocompatible thermoplastic sheet upon the membrane, perforating the sheet.

8. The method of claim 1 further comprising marking the formed orthodontic aligner with the information or a portion of the information, wherein the marking comprises laser marking by a laser marking apparatus that reads the aligner identifier from the RFID chip, queries the database for the information related to the aligner identifier, and laser marks the information or the portion of the information onto the formed orthodontic aligner,
the method further comprising reading the RFID chip to determine the aligner identifier, querying the database and retrieving the digital dental model corresponding to the aligner identifier, and trimming the formed orthodontic aligner to substantially match the retrieved digital dental model.

9. The method of claim 1 further comprising cutting the biocompatible thermoplastic sheet from a precursor thermoplastic sheet using artificial intelligence and/or machine learning to optimize cuts.

10. The method of claim 9 further comprising, prior to the placing the biocompatible thermoplastic sheet upon the membrane, incorporating additive(s) into the precursor thermoplastic sheet or the cut biocompatible thermoplastic sheet.

11. The method of claim 10 wherein the additive(s) comprise lateral flow assay (LFA) strip(s) or antimicrobial agent(s).

12. A method of forming an orthodontic aligner, the method comprising:
(a) forming a dental model corresponding to a teeth digital model;
(b) defining a virtual edge of the teeth digital model wherein the teeth digital model with the virtual edge define a three-dimensional shape of the aligner;
(c) computationally converting the three-dimensional shape into a developed surface having a two-dimensional shape;
(d) cutting the two-dimensional shape from a biocompatible thermoplastic sheet to form a pre-cut aligner sheet; and
(e) thermoforming the pre-cut aligner sheet over the dental model, thereby forming the orthodontic aligner.

13. The method of claim 12, further comprising, after step (d):
(d1) placing the pre-cut aligner sheet onto a membrane housed within a chamber, the membrane forming a physical barrier between the pre-cut aligner sheet and the chamber.

14. The method of claim 13 further comprising, after step (d1):
(d2) placing the membrane and the pre-cut aligner sheet over the dental model, and pressurizing the chamber to cause the membrane to form the pre-cut aligner sheet over the dental model.

15. The method of claim 13, wherein the membrane is pliable and comprises a non-stick material reusable over multiple cycles.

16. The method of claim 12, wherein defining the virtual edge comprises defining a line displaced below a gingival line of the teeth digital model around the teeth digital model.

17. The method of claim 13 wherein a material finish of the membrane affects a surface finish of the formed orthodontic aligner, stretching the membrane altering the material finish of the membrane.

18. The method of claim 17 further comprising varying a stretch of the membrane to alter the surface finish of the formed orthodontic aligner.

19. The method of claim 12 wherein the dental model, the corresponding teeth digital model, and the formed orthodontic aligner are of upper and lower arches of a patient's teeth.

20. The method of claim 13 wherein the pre-cut aligner sheet leaves open one or more occlusal surfaces.
